(19) United States
(12) Patent Application Publication
(10) Pub. No.: US 2020/0329682 A1
(43) Pub. Date: Oct. 22, 2020

(54) METHOD OF INCREASING OXYGEN LEVELS IN AQUACULTURE

(71) Applicant: AOE ACCUMULATED OCEAN ENERGY INC., Victoria (CA)

(72) Inventors: Jim MATEI, Victoria (CA); Benjamin D. LEE, Calgary (CA); Christopher W. GARDNER, Hood River, OR (US)

(21) Appl. No.: 16/851,934

(22) Filed: Apr. 17, 2020

(30) Foreign Application Priority Data
Apr. 18, 2019 (CA) 3040762

(51) Int. Cl. A01K 63/04

(52) U.S. Cl. CPC A01K 63/042; A01K 63/045; A01K 63/047

(57) ABSTRACT

A method of increasing oxygen levels in aquaculture involves pumping water from a body of water into a temporary holding tank and storing air under pressure in a storage vessel. The method involves enriching a stream of pressurized air from the air storage vessel by the introduction of oxygen from a downstream source of oxygen and directing the oxygen enriched stream of pressurized air into water drawn from the temporary water holding tank. The method then involves passing the oxygen enriched stream of pressurized air and water through at least one mixer, whereby a mixing of the oxygen enriched stream of air into the water occurs to create oxygenated water. The oxygenated water in then introduced into water used for aquaculture at an aquaculture facility.

### FIELD

There is described a method of increasing oxygen levels in aquaculture.

### BACKGROUND

Maintaining oxygen levels is a chronic problem in aquaculture. Using fish farming as an example, if fish in pens are oxygen starved; the fish become increasingly lethargic as dissolved oxygen levels drop and increasingly vulnerable to parasites. If dissolved oxygen levels continue to drop, fish mortality increases dramatically. Some fish farms are presently experiencing fish mortality rates of 40 percent or more.

In some installations, aerators are used to aerate the water. When an increase in dissolved oxygen levels is urgently required to prevent fish mortality, pure oxygen is injected into the water of the fish pen as a form of bubbling oxygenation.

### SUMMARY

There is provided a method of increasing oxygen levels in aquaculture involves pumping water from a body of water into a temporary holding tank and storing air under pressure in a storage vessel. The method involves enriching a stream of pressurized air from the air storage vessel by the introduction of oxygen from a downstream source of oxygen and directing the oxygen enriched stream of pressurized air into water drawn from the temporary water holding tank. The method then involves passing the oxygen enriched stream of pressurized air and water through at least one mixer, whereby a mixing of the oxygen enriched stream of air into the water occurs to create oxygenated water. The oxygenated water in then introduced into water used for aquaculture at an aquaculture facility.

The method, as described above, is believed to be more effective and easier to control than bubbling oxygenation in which oxygen is injected directly into the aquaculture pens and is bubbled to surface.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a flow diagram of the water and air preparation steps of the method of increasing oxygen levels in aquaculture.

FIG. 2 is a flow diagram of the mixing steps of the method of increasing oxygen levels in aquaculture.

FIG. 3 is a flow diagram of solids waste removal steps of the method of increasing oxygen levels in aquaculture.

### DETAILED DESCRIPTION

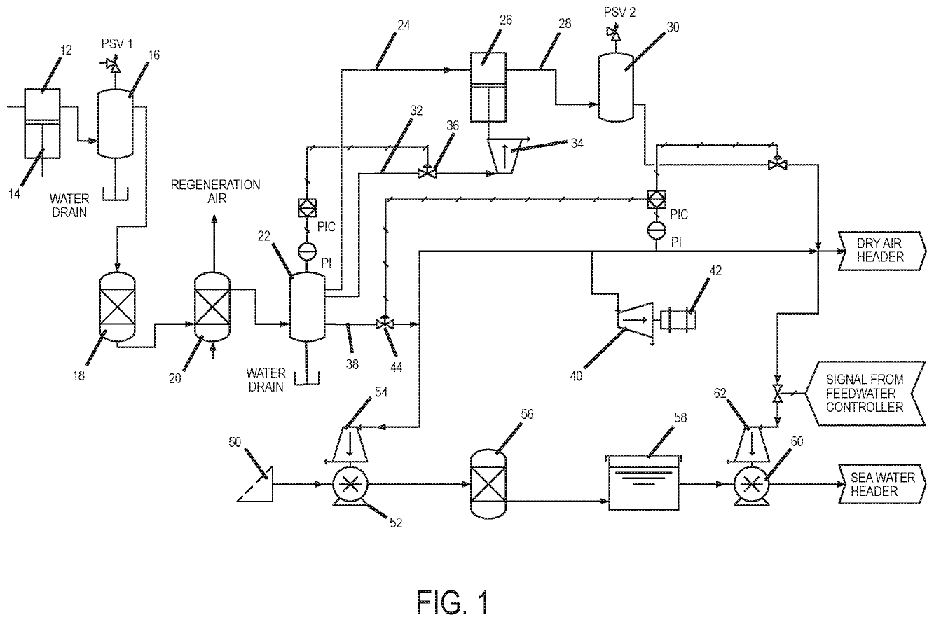

A method of increasing oxygen levels in aquaculture will now be described with reference to FIG. 1 through FIG. 3.

By way of example, the method will be described with reference to salmon aquaculture. Salmon aquaculture requires 11 parts per million of dissolved oxygen in seawater to maintain healthy environment for Salmon. In a healthy environment, the Salmon remain active, which assists in the Salmon's resistance to sea lice and disease. The source of air for use with the method is not critical. However, due to the fact that Salmon aquaculture is usually conducted at remote locations, it is preferred that compressed air is produced by harnessing energy from ocean waves.

### Structure and Relationship of Parts:

Referring to FIG. 1, components relating to air include an air source 12. Air source 12 has been illustrated as having a reciprocating piston 14 driven by ocean waves. It will be appreciated that any air source could be used. Reciprocating piston 14 from air source 12 forces air into a first stage air accumulator 16. Air from first stage air accumulator 16 passes through an air filter 18 into an air dryer 20. Air exiting air dryer 20 enters second stage air accumulator 22. Air from second stage air accumulator 22 is used in three ways. A first stream of air from second stage air accumulator 22 passes along line 24 to air compressor 26, where the air is compressed. Compressed air exiting air compressor 26 passes along line 28 into pressurized air storage vessel 30. A second stream of air from second stage air accumulator 22 passes along line 32 to pneumatic motor 34, which drives air compressor 26. An isolation valve 36 is provided to selectively shut off and control the flow of air along line 32. A third stream of air from second stage air accumulator 22 passes along line 38 to pneumatic motor 40, which drives electric generator 42. An isolation valve 44 is provided to selectively shut off and control the flow of air along line 38. Also along line 38 are pneumatic motors used to drive water pumps, which will hereinafter be further described.

Further referring to FIG. 1, components relating to water movement include a water inlet screen 50. A water pump 52 driven by a pneumatic motor 54 draws water (in this case sea water) through water inlet screen 50. Water then passes through a filter 56 and into a water holding tank 58. When oxygenation of the water is to be initiated water pump 60 is activated and driven by pneumatic motor 62.

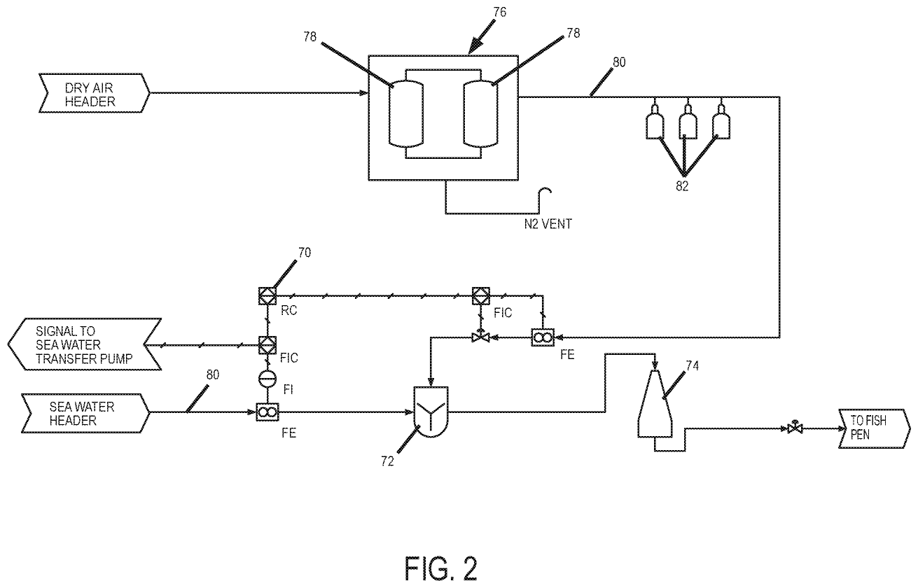

Referring to FIG. 2, components relating to mixing include a water/oxygenated air ratio controller 70 and rotating turbine inline mixer 72 and a conical mixing tank 74. The oxygenated air for the method passes through a pressure swing absorption assembly, generally indicated by reference numeral 76. Pressure swing absorption assembly 76 includes two expansion tanks 78. Pressurized air feed line 80 extends to inline mixer 72 with a branch extending to water/oxygenated air ratio controller 70. Oxygen storage containers 82 are positioned on pressurized air feed line 80 downstream of pressure swing absorption assembly 76.

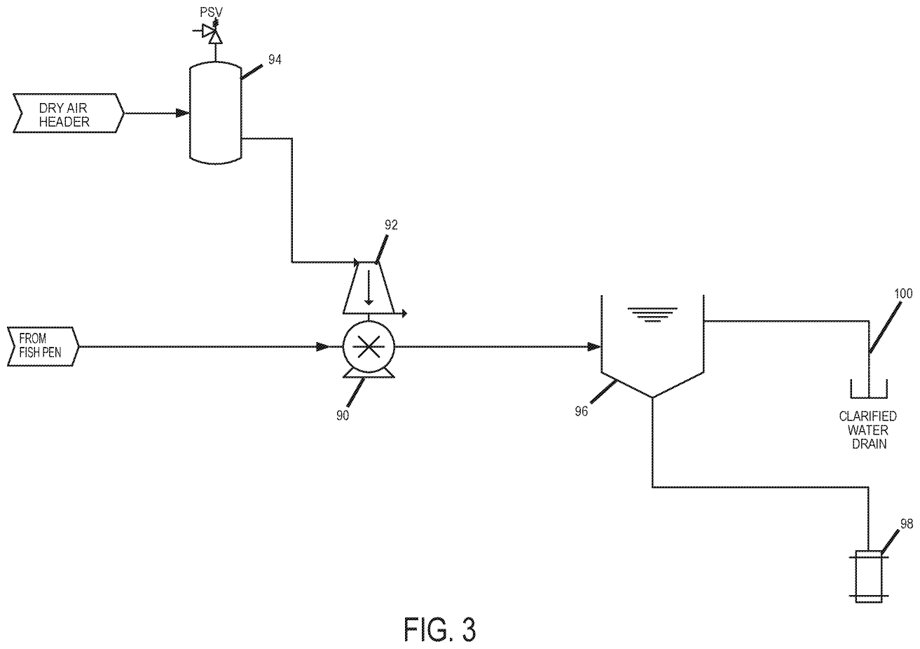

Referring to FIG. 3, components of waste removal system include a water pump 90 that draws water contaminated by fish faeces and other contaminates from the fish pens. Water pump 90 is driven by a pneumatic motor 92 that is supplied air from a pressurized air storage vessel 94. Water pump 90 pumps the contaminated water to a solids waste clarifier 96 (which is a form of settling tank). Solids settle to the bottom of solids waste clarifier 96 and are removed to a sludge container 98. Clarified water is drawn from an upper portion of solids waste clarifier 96 through an outlet line 100.

### Operation:

The method of increasing oxygen levels in aquaculture involves the following steps. Referring to FIG. 1, one step involves using water pump 52 to draw water from a body of water through water inlet screen 50 and pump the water through filter 56 to remove contaminants and then into a temporary water holding tank 58. One step involves passing air from an air source through air filter 18 to remove contaminants and air dryer 20 to reduce moisture prior to compression, then compressing the air in air compressor 26 and storing the pressurized air in air storage vessel 30. Referring to FIG. 2, one step involves enriching a stream of pressurized air from air storage vessel 30 by the introduction of oxygen from oxygen storage containers 82 which are positioned downstream (past pressure swing absorption assembly 76) and then directing the oxygen enriched stream of pressurized air into water drawn from temporary water holding tank 58. One step involves passing the oxygen enriched stream of pressurized air and water through at least one mixer, whereby a mixing of the oxygen enriched stream of air into the water occurs to create oxygenated water. As described above, two mixers are preferred rotating turbine inline mixer 72 and conical mixing tank 74. Relative ratios of water and pressurized air can also be controlled through the use of water/oxygenated air ratio controller 70. A final step involves introducing the oxygenated water through outlet line 100 into water used for aquaculture at an aquaculture facility.

Referring to FIG. 3, where fish pens become contaminated with fish faeces, water pump 90 pumps contaminated water to solids waste clarifier 96. Solids settle to the bottom of solids waste clarifier 96 and are removed to sludge container 98. Clarified water is drawn from an upper portion of solids waste clarifier 96 through outlet line 100.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A method of increasing oxygen levels in aquaculture, comprising:
pumping water from a body of water into a temporary holding tank;
storing air under pressure in a storage vessel;
enriching a stream of pressurized air from the air storage vessel by the introduction of oxygen from a downstream source of oxygen;
directing the oxygen enriched stream of pressurized air into water drawn from the temporary water holding tank;
passing the oxygen enriched stream of pressurized air and water through at least one mixer, whereby a mixing of the oxygen enriched stream of air into the water occurs to create oxygenated water; and
introducing the oxygenated water into water used for aquaculture at an aquaculture facility.

2. A method of increasing oxygen levels in aquaculture, comprising:
pumping water from a body of water through a filter to remove contaminants and then into a temporary water holding tank;
passing air from an air source through an air filter to remove contaminants, and an air dryer to reduce moisture prior to compression, then compressing the air in an air compressor and storing the pressurized air in an air storage vessel;
enriching a stream of pressurized air from the air storage vessel by the introduction of oxygen from a downstream source of oxygen;
directing the oxygen enriched stream of pressurized air into water drawn from the temporary water holding tank;
passing the oxygen enriched stream of pressurized air and water through at least one mixer, whereby a mixing of the oxygen enriched stream of air into the water occurs to create oxygenated water; and
introducing the oxygenated water into water used for aquaculture at an aquaculture facility.

3. The method of claim 2, wherein the at least one mixer includes an inline turbine mixer and a conical mixer.

4. The method of claim 2, wherein the body of water is the aquaculture facility and a solids waste clarifier is provided to remove solids waste from the water of the aquaculture facility.

5. The method of claim 2, wherein pressurized air is used to run the pumps.

6. The method of claim 2, wherein pressurized air is used to run the air compressor.

7. The method of claim 2, wherein pressurized air is used to run an electric generator which generates electricity.
